(19) United States
(12) Patent Application Publication
(10) Pub. No.: US 2023/0368683 A1
(43) Pub. Date: Nov. 16, 2023

(54) SYSTEM AND METHOD FOR REAL TIME CONTROL OF THE TRAJECTORY OF AN AIRCRAFT ON A RUNWAY

(71) Applicants: SAFRAN LANDING SYSTEMS, VELIZY-VILLACOUBLAY (FR); SAFRAN ELECTRONICS & DEFENSE, PARIS (FR); SAFRAN AIRCRAFT ENGINES, PARIS (FR)

(72) Inventors: Hakim MAALIOUNE, MOISSY CRAMAYEL (FR); Laurent MIRALLES, MOISSY CRAMAYEL (FR); Christophe BASTIDE, MOISSY CRAMAYEL (FR); Jérémy Edmond FERT, MOISSY CRAMAYEL (FR); Vincent HUPIN, MOISSY CRAMAYEL (FR)

(21) Appl. No.: 18/247,011

(22) PCT Filed: Sep. 14, 2021
(86) PCT No.: PCT/FR2021/051565

§ 371 Date: Mar. 28, 2023

(30) Foreign Application Priority Data
Oct. 1, 2020 (FR) FR2010030

(51) Int. Cl. G08G 5/06; G08G 5/00

(52) U.S. Cl. CPC G08G 5/065; G08G 5/0013; G08G 5/0065; G08G 5/0091

(57) ABSTRACT

A system for real-time control of the trajectory of an aircraft on a runway, includes at least one steering system configured to steer the aircraft on the ground, each steering system being associated with at least one use parameter; a computer configured for determining, from aircraft data and external data including runway condition data and ground meteorological data, each steering system intended to steer the aircraft according to a predetermined trajectory and each corresponding use parameter; and a control system configured to control each steering system determined according to each corresponding determined use parameter.

### TECHNICAL FIELD OF THE INVENTION

The technical field of the invention is that of aircraft and more particularly that of systems and methods for controlling the trajectory of an aircraft on a ground runway.

The present invention relates to a system for controlling the trajectory of an aircraft on a runway and in particular to a system for controlling in real time the trajectory of an aircraft on a runway. The present invention also relates to a control method implemented by the system.

### TECHNOLOGICAL BACKGROUND OF THE INVENTION

Aircraft runway excursions are numerous, in the order of one per month worldwide, and are due, in about 25% of cases, to a poor choice of piloting during landing in deteriorated weather conditions.

In view of this, the aeronautical authorities require the implementation of solutions to reduce the number of runway excursions, and in particular the number of transverse runway excursions.

Transverse runway excursions are linked to poor management of the steering means to direct the aircraft when runway conditions are degraded.

Currently, the distribution of the use of the steering means to obtain a predetermined trajectory is calculated by a law giving the distribution between the use of the nose landing gear and the use of the rudder as a function of the aircraft speed. According to this law, at low speeds, the aircraft is steered by the wheels of the nose landing gear. As the speed increases, the use of the nose landing gear decreases and the rudder is used instead. The distribution of the use of the aircraft steering means therefore depends solely on its speed, and therefore does not especially take account of the weather conditions likely to influence the aircraft trajectory.

There is therefore a need for a system that allows the trajectory of an aircraft to be controlled and has a reduced risk of transverse runway excursions.

### SUMMARY OF THE INVENTION

The invention provides a solution to the problems discussed above, by providing an aircraft trajectory control system that limits the risk of transverse runway excursions.

A first aspect of the invention relates to a system for controlling in real time the trajectory of an aircraft on a ground runway, including:
Steering means configured to steer the aircraft on the ground, each steering means being associated with at least one usage parameter;
A calculator configured to:
   Determine, from aircraft data and external data including runway state data and ground weather data, each steering means for steering the aircraft along a predetermined trajectory and each corresponding usage parameter;
control means configured to control each determined steering means according to each corresponding determined usage parameter.

By virtue of the invention, the calculator determines the steering means and the associated usage parameter(s) enabling the aircraft to follow a predetermined trajectory on the runway and which takes account, on the one hand, of the aircraft data and, on the other hand, data relating to the state of the runway and to the weather conditions on the ground.

Further to the characteristics just discussed in the preceding paragraph, the system according to the first aspect of the invention may have one or more complementary characteristics among the following, considered individually or according to any technically possible combinations.

According to one alternative embodiment, the steering means include a nose landing gear comprising at least one wheel and a plurality of thrust reversers each equipped on an engine of the aircraft.

According to one sub-alternative embodiment of the preceding alternative embodiment, the steering means further includes a rudder.

According to a first embodiment compatible with the preceding alternative embodiment, the control means includes a single central controller.

Thus, the central controller is configured to control each steering means, and in particular each determined steering means according to the corresponding determined usage parameter(s). The number of calculators and thus the mass of the control means is minimised, which especially allows fuel consumption to be limited.

According to a second embodiment compatible with the preceding alternative embodiment, the control means include a central controller and one controller per steering means.

Thus, each controller is configured to control a single steering means and the central controller is configured to control each of the controllers as a function of each determined steering means and each determined corresponding usage parameter. Thus, it is sufficient to equip existing aircraft with a central calculator for the control system to be implemented.

According to one alternative embodiment compatible with the preceding alternatives and embodiments, the aircraft includes engines and braking means configured to brake the aircraft and the aircraft data includes aircraft speed and/or steering means availability data and/or braking means usage data and/or engine usage data.

Thus, the determination of the steering means and their usage parameters takes account of the current aircraft speed and the future aircraft speed, through information on the braking means used and the engine usage, and thus the aircraft deceleration rate. The determination of the steering means and their usage parameters also takes account of the availability of the steering means, to use only those steering means that can be used or that it is advantageous to use.

According to one sub-alternative embodiment of the preceding alternative embodiment, the availability data of a steering means includes data relating to the state of the steering means and/or data relating to the cost of using the steering means.

Thus, the determination of the steering means and their usage parameters takes account of the operating capacity of each steering means and/or its cost of use, for example through the wear that use causes on the steering means and/or the fuel consumption that use of the steering means causes.

According to one alternative embodiment compatible with the preceding alternatives and embodiments, the system includes first communication means configured to communicate with a ground station.

In this way, the system can obtain external data from the control tower in charge of landings on the runway, in accordance with the regulations.

According to one alternative embodiment compatible with the preceding alternatives and embodiments, the system includes second communication means configured to communicate with at least one other aircraft.

Thus, the calculator may use determinations of steering means and their usage parameters made by other aircraft that have previously landed on the runway.

A second aspect of the invention relates to an aircraft including a system according to the first aspect of the invention.

A third aspect of the invention relates to a method for controlling in real time the trajectory of an aircraft on a ground runway implemented by the system according to the first aspect of the invention, including the following steps of:
Determining, by the calculator, from aircraft data and external data including runway state data and ground weather data, of each steering means for steering the aircraft along a predetermined trajectory and of each corresponding usage parameter;
Implementing each steering means determined according to each corresponding usage parameter determined by the control means.

According to one alternative embodiment, the implementation is automatic or manual.

Thus, the pilot may choose to implement him/herself each steering means according to each corresponding usage parameter.

According to one alternative embodiment compatible with the preceding alternative embodiment, the determination step is performed as soon as the aircraft data and/or the external data are modified.

Thus, the steering means and the associated usage parameters implemented are updated in real time according to the aircraft data and/or the external data.

A fourth aspect of the invention relates to a computer program product comprising instructions which, when the program is executed by a computer, cause the same to implement the steps of the method according to the third aspect of the invention.

A fifth aspect of the invention relates to a computer-readable recording medium comprising instructions which, when executed by a computer, cause the same to implement the steps of the method according to the third aspect of the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of an aircraft.

FIG. 2 shows a schematic representation of a first embodiment of a control system according to the invention.

FIG. 3 shows a schematic representation of a second embodiment of a control system according to the invention.

FIG. 4 is a block diagram illustrating the steps of a control method according to the invention.

### DETAILED DESCRIPTION

Unless otherwise specified, a same element appearing in different figures has a single reference.

A first aspect of the invention relates to a system for controlling in real time the trajectory of an aircraft on a runway.

The objective of the invention is to avoid runway excursion of the aircraft, more particularly between the landing of the aircraft and the arrival at its parking point. The control system therefore enables the aircraft to be maintained on a predetermined trajectory on the runway.

The predetermined trajectory is, for example, the trajectory passing through the middle of the runway.

The predetermined trajectory could also be, for example, a trajectory determined from the state of the runway, for example a trajectory to avoid dangerous zones on the runway, such as zones with dips or bumps that could damage the aircraft.

By “real-time control of the aircraft trajectory”, it is meant that data relating to the actual aircraft trajectory are processed immediately after acquisition, and that the time between the acquisition of the trajectory data and the generation of control instructions for adjusting the actual aircraft trajectory to the predetermined trajectory is minimised.

FIG. 2 shows a schematic representation of the control system 200 according to a first embodiment.

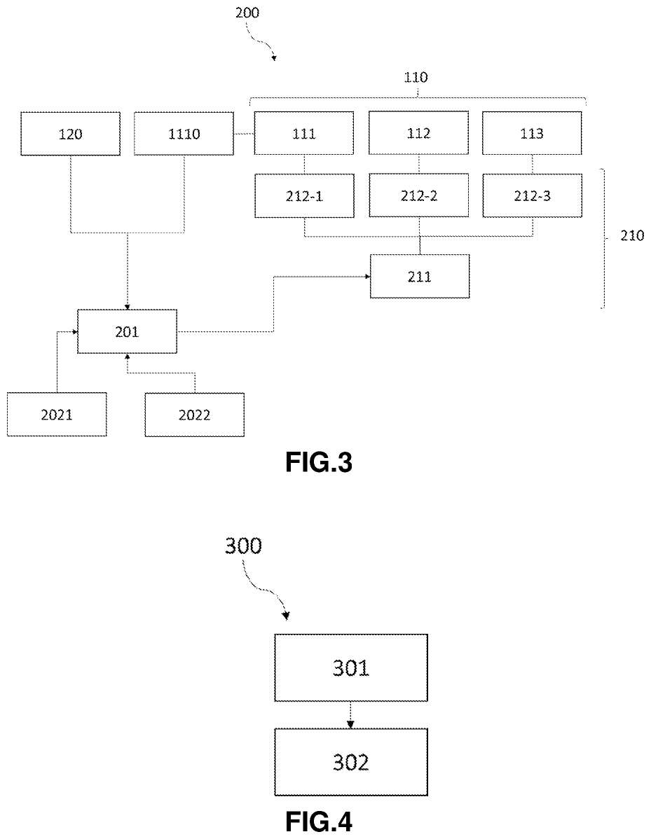

FIG. 3 shows a schematic representation of the control system 200 according to a second embodiment.

As illustrated in FIG. 2, the control system 200 includes:
Steering means 110
A calculator 201
A control means 210 including at least one central calculator 211.

The steering means 110 are configured to steer the aircraft on the ground, that is the steering means 110 are capable of changing the trajectory of the aircraft 100 on the ground.

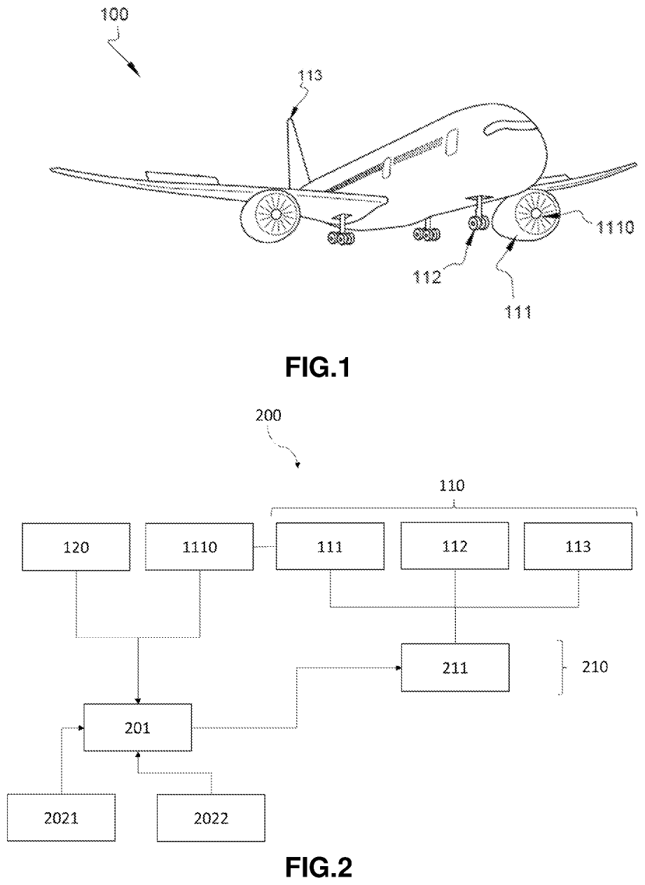

FIG. 1 shows a schematic representation of an aircraft 100.

As illustrated in FIG. 1, the steering means 110 includes a plurality of thrust reversers 111 and a nose landing gear 112. The aircraft 100 includes a plurality of engines 1110, each engine 1110 having a thrust reverser 111. The landing gear 112 includes a plurality of wheels.

The steering means 110 may also include a rudder 113, as in FIG. 1.

Each steering means 110 is associated with at least one usage parameter.

A usage parameter of the thrust reversers 111 is, for example, the usage power.

A usage parameter of the rudder 113 is, for example, the angle of the rudder 113.

The calculator 201 is configured to determine the one or more steering means 110 for steering the aircraft 100 along the predetermined trajectory and the one or more associated usage parameters.

The determination includes, for example, the use of the left thrust reverser 111 with a first given power, of the right thrust reverser 111 with a second given power and of the rudder 113 at a given angle.

The determination is, for example, performed at the time of landing of the aircraft 100, during the first contact between the runway and the aircraft 100.

The determination is made from aircraft data, that is data relating to the aircraft, and external data, that is data relating to conditions external to the aircraft 100.

The external data includes data relating to the state of the runway, for example the coefficient of friction of the runway, and data relating to the weather conditions at the runway, for example the wind strength and direction.

The external data may be obtained from a ground control tower in charge of the runway. In this case, the system 200 includes first communication means 2021 allowing to communicate with the control tower and generally with a ground station.

The aircraft data includes, for example, the speed of the aircraft 100, data relating to the availability of the steering means 110, for example whether a given steering means 110 is inoperative or functioning, data relating to the use by the aircraft 100 of its engines 1110, for example the power delivered by each engine 1110, or data relating to the use by the aircraft 100 of its braking means 102 configured to brake the aircraft 100, for example which braking means 102 are activated and how the speed of the aircraft 100 will change depending on which braking means 102 is activated.

The data relating to the availability of some steering means 110 includes data relating to the state of the steering means 110, for example whether the steering means 110 is functioning or inoperative or the rate of wear of the steering means 110, and/or data relating to the cost of using the steering means 110, for example the fuel consumption associated with the use of the steering means 110 or the replacement price of the steering means 110.

The determination may also be made using data from other aircraft 100, for example aircraft 100 that have already landed on the runway. In this case, the system 200 includes second communication means 2022 for communicating with the other aircraft 100.

The determination is for example made as soon as the aircraft data and/or external data are modified.

The control means 210 are configured to control the steering means 110 in accordance with the determination.

According to the first embodiment of the system 200 illustrated in FIG. 2, the control means 210 includes a single central controller 211 configured to control all the steering means 110.

According to the second embodiment of the system 200, the control means 210 include one central controller 211 and one controller 212 per steering means 110 configured to control the steering means upon instruction from the central controller 211.

In FIG. 3, the control means 210 includes a central controller 211, a controller 212-1 configured to control the thrust reversers 111, a controller 212-2 configured to control the nose landing gear 112 and a controller 212-3 configured to control the rudder 113.

A second aspect of the invention relates to an aircraft 100 equipped with the system according to the first aspect of the invention.

A third aspect of the invention relates to a method for controlling in real time the trajectory of the aircraft 100 implemented by the system 200 according to the first aspect of the invention.

FIG. 4 is a block diagram illustrating the steps of the method 300 according to the third aspect of the invention.

A first step 301 of the method 300 implemented by the calculator 201, is to determine each steering means 110 and each corresponding usage parameter based on aircraft data and external data.

A second step 302 of the method 300 implemented by the control means 210, is to implement the determination on the steering means 110.

The implementation of the steering means 110 may be performed automatically or manually by the pilot of the aircraft 100.

In the case of manual implementation, guidance may be provided to assist the pilot.

The first step 301 is for example performed as soon as the aircraft data and/or external data are modified.

1. A system for controlling in real time a trajectory of an aircraft on a ground runway, including:
steering means configured to steer the aircraft on the ground, each steering means being associated with at least one usage parameter;
a calculator configured to:
determine, from aircraft data and external data obtained by first communication means and including runway state data and ground weather data, each steering means for steering the aircraft along a predetermined trajectory and each corresponding usage parameter, and
control means configured to control each steering means determined in accordance with each corresponding determined usage parameter.

2. The system according to claim 1, wherein the steering means include a nose landing gear comprising at least one wheel and a plurality of thrust reversers each fitted to an engine of the aircraft.

3. The system of claim 2, wherein the steering means further include a rudder.

4. The system according to claim 1, wherein the control means include a central controller.

5. The system according to claim 4, wherein the control means further include one controller per steering means.

6. The system according to claim 1, wherein the aircraft data includes speed of the aircraft and/or availability data of steering means and/or usage data of braking means of the aircraft and/or usage data of engines of the aircraft.

7. The system according to claim 6, wherein the availability data of a steering means includes data relating to the state of the steering means and/or data relating to the cost of using the steering means.

8. The system according to claim 1, further comprising first communication means configured to communicate with a ground station.

9. The system according to claim 1, further comprising second communication means configured to communicate with at least one other aircraft.

10. An aircraft including the system according to claim 1.

11. A method for controlling in real time the trajectory of an aircraft on a ground runway implemented by the system according to claim 1, comprising:
determining, by the calculator, from aircraft data and external data obtained by first communication means and including runway state data and ground weather data, of each steering means for steering the aircraft along a predetermined trajectory and of each corresponding usage parameter, and
implementing each steering means determined according to each corresponding usage parameter determined, by the control means.

12. The method according to claim 11, wherein the implementation is automatic or manual.

13. The method according to claim 11, wherein the determination step is performed as soon as the aircraft data and/or the external data are modified.

14. (canceled)

15. A non-transitory computer-readable recording medium comprising instructions which, when executed by a computer, cause the computer to implement the method according to claim 11.
